(19) United States
(12) Patent Application Publication
(10) Pub. No.: US 2020/0143437 A1
(43) Pub. Date: May 7, 2020

(54) SYSTEMS AND METHODS FOR INDIVIDUALIZED RESTAURANT RATING

(71) Applicant: Luke Luechtefeld, Des Peres, MO (US)

(72) Inventor: Luke Luechtefeld, Des Peres, MO (US)

(21) Appl. No.: 16/676,134

(22) Filed: Nov. 6, 2019

Related U.S. Application Data
(60) Provisional application No. 62/756,309, filed on Nov. 6, 2018.

(51) Int. Cl. G06Q 30/02; G06Q 50/12; G06F 16/2457

(52) U.S. Cl. CPC G06Q 30/0282; G06F 16/24578; G06Q 50/12

(57) ABSTRACT

Disclosed herein are systems, methods and procedures for ranking restaurants in an individualized restaurant scoring system.

### CROSS REFERENCE TO RELATED APPLICATIONS

This application claims priority under 35 USC § 119(e) to U.S. Patent Application Ser. No. 62/756,309, filed on Nov. 6, 2018, the entire contents of which are hereby incorporated by reference.

### FIELD

The present technology pertains to methods and systems for generating individualized restaurant ratings.

### BACKGROUND

Consumers have many choices when it comes to restaurants and eating establishments. Consumers consider many factors when selecting a restaurant, including location, price, availability, style, atmosphere, menu, particular meals and other factors. Review sites allow users to rate or provide reviews of restaurants. However, many consumers have different opinions about what makes a particular establishment better than another, and it can be difficult to determine if one person's rating and/or review of a restaurant will be particularly relevant to the individual searching for a place to eat.

Thus, given that individuals prioritize various aspects of a dining experience differently, it would be highly desirable to provide a system and method for creating individualized or personalized ratings for an individual user.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a flow diagram illustrating the method of applying the weighting factors to rank restaurants in accordance with the present disclosure.

FIG. 2 illustrates an example of a weighting factor customization page in accordance with the present disclosure.

FIG. 3 illustrates an embodiment of a display of a list of restaurants ranked according to a method of the disclosure presented to the consumer. The restaurant aggregate score 120 for each restaurant in the list is shown.

FIG. 4A illustrates a display of detailed category rating data for each category of restaurant rating presented to the consumer.

FIG. 4B illustrates a display of more detailed rating data for each category of restaurant rating presented to the consumer.

FIG. 5 illustrates a display of consumer comments such as complaints or praise experienced by the consumer for each category of restaurant rating as presented to the consumer.

FIG. 6 is a flow diagram illustrating a method of generating individualized ranking scores for restaurants in accordance with the present disclosure.

FIG. 6 illustrates a display of options presented to the consumer to find a restaurant using a method of the disclosure 310 or to rate categories of restaurant rating for a restaurant 300.

FIG. 7 illustrates a display of a star rating system 400 presented to a consumer to provide a rating score for each category of restaurant rating.

FIG. 8 illustrates an alternate embodiment of a display of a list of restaurants ranked according to a method of the disclosure presented to the consumer. The restaurant aggregate score 120 for each restaurant in the list is shown.

FIG. 9 illustrates a display presenting the consumer with an option to elect finding a restaurant 700, or elect to add new ratings to a restaurant 710.

FIG. 10 illustrates a block diagram of a remote restaurant rating system, in accordance with the present disclosure.

FIG. 11 illustrates a conventional system bus computing system architecture 700.

FIG. 12 illustrates an example computer system 750 having a chipset architecture that can be used in executing the described method and generating and displaying a graphical user interface (GUI).

Corresponding reference characters indicate corresponding elements among the view of the drawings. The headings used in the figures do not limit the scope of the claims.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

In the following description, illustrative examples will be described with reference to acts and symbolic representations of operations (e.g., in the form of flow charts, flow diagrams, data flow diagrams, structure diagrams, block diagrams, etc.) that may be implemented as program modules or functional processes including routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

### I. Ranking Restaurants

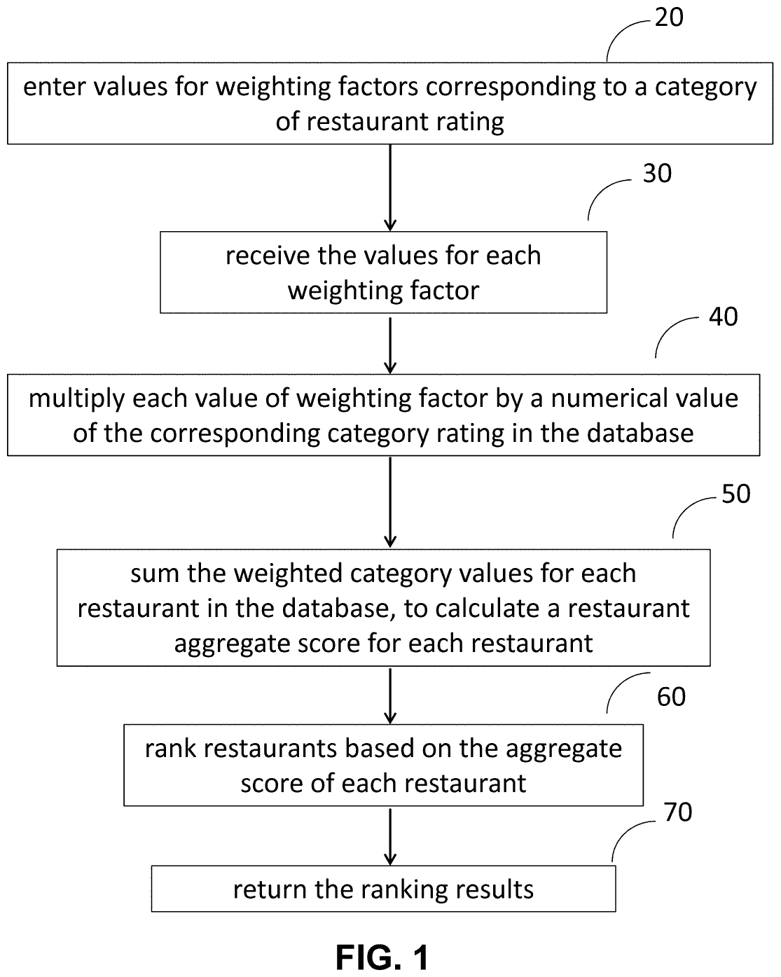

Disclosed are methods for ranking restaurants in a personal restaurant scoring system. Referring to the illustrative block diagram of FIG. 1, the method comprises entering by a consumer a value for each of a set of weighting factors 20 prior to receiving query information related to a potential selection of a restaurant. Each weighting factor corresponds to a category of restaurant rating, and the value of each weighting factor represents the relative importance to be given by the consumer to the corresponding category of restaurant rating in ranking the restaurants. The method further comprises receiving the query information relating to said selection of a restaurant from the consumer 30 and applying the values of weighting factors to a list of restaurants from a database. Applying the values of weighting factors comprises multiplying each weighting factor by a value of the corresponding category rating in the database, to produce a weighted category value for each category of restaurant rating 40. A restaurant aggregate score for said each restaurant in the database is calculated by summing the plurality of weighted category values for each restaurant in the database 50, and ranking said list of restaurants based on the calculated restaurant aggregate scores to produce a ranking result for each restaurant 60. The ranking results are then returned to the consumer 70, wherein the ranking results are listed in an order corresponding to the ranking result of each restaurant.

Each said weighting factor entered by the consumer represents the relative importance to be given by the consumer to the corresponding category of restaurant rating information in ranking the restaurants. The weighting factor may be a rating score ranging from 0-100, 0-50, from 0-10, preferably from 0 to 1. Irrespective of the range of rating score used in a method of the disclosure, the sum value of the weighting factors is a reference number equal to the highest value of the range in the rating score. For instance, when the weighting factor is a rating score ranging from 0 to 1, the sum value of the weighting factors entered by a consumer equals the reference number 1, the highest value of the range of the rating score. Similarly, when the weighting factor is a rating score ranging from 0 to 100, the sum value of the weighting factors entered by a consumer equals the reference number 100, the highest value of the range of the rating score.

A consumer may elect to enter a value for all weighting factors presented to the consumer. Alternatively, a consumer may elect to enter a value for only a subset of weighting factors selected by the consumer. When the consumer enters a value for only a subset of weighting factors, weighting factors not weighted by the consumer are attributed a value of 0. Further, when the consumer enters a value for only a subset of weighting factors, the values entered for selected weighting factors may be adjusted to provide a sum value equal to the reference number of the rating score. Alternatively, a consumer may elect to not enter a value for any of weighting factors selected by the consumer. In this case, the weighting factors may all be attributed the same value. In an embodiment, each of the weighting factors may be pre-set with the same value until modified by the consumer.

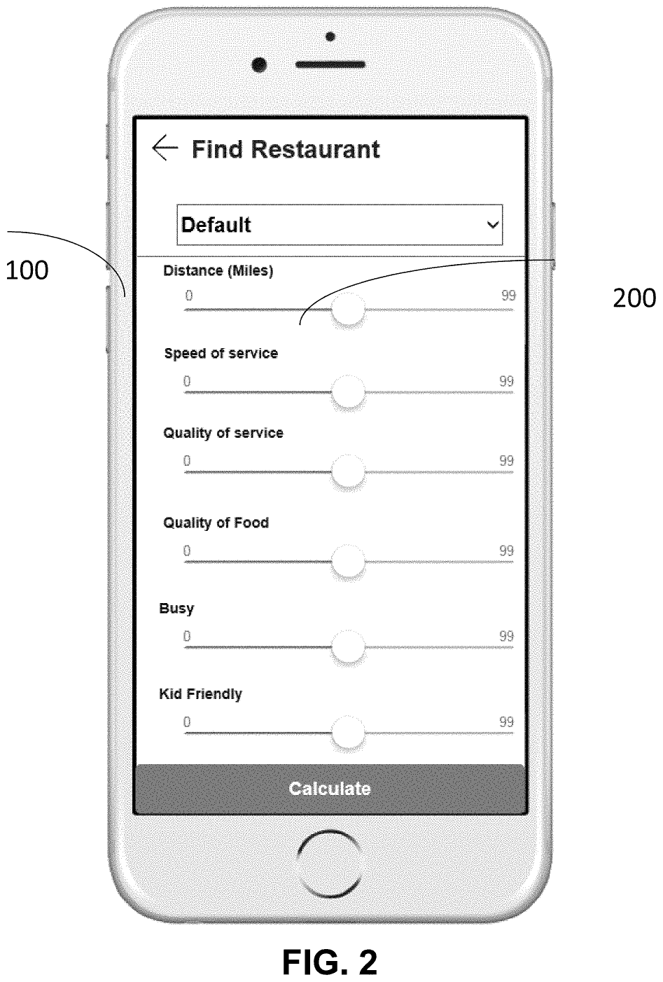

The process of a consumer customizing the weighting factors may be as illustrated in FIG. 2. The user is first presented with a set of restaurant rating categories 100, wherein the weighting factor corresponding to each category of restaurant rating can be selected by the consumer by selecting a value for the weighting factor. The value corresponding to each weighting factor represents the relative importance to be given by the consumer to the corresponding category of restaurant rating in ranking the restaurants. Any number of methods may be used to select a value by the consumer. For instance, the consumer may select a value for each weighting factor corresponding to a category of restaurant rating by moving a slider 200 for selecting the value as illustrated in FIG. 2. Alternatively, the value for each weighting factor may be selected by typing the value for each weighting factor, or selecting the value for each weighting factor from a list of weighting values. The value may also be selected by selecting the number of stars in a star rating system.

The categories of restaurant rating may be selected from any number of categories for rating a restaurant that may be relevant to a restaurant consumer. Non-limiting examples of restaurant rating categories include price, quality of service, speed of service, quality of food, variety of food, popularity, crowdedness, kid friendliness, distance from a location, healthiness of food served, serving size, ambiance, food portion size, drink variety, presence or absence of televisions, and capacity.

The values of weighting factors are applied to a list of restaurants from a database of values of category rating for each restaurant in the list. The value of category rating corresponding to each category of restaurant rating is obtained from a database of category ratings. A value of category rating may be an average value for each category, wherein the average value for each category is generated from values contributed by consumers to the database for each category of restaurant rating. For instance, an average value may be generated as described in Section III below. Alternatively, or additionally, a database of ratings may be a database of the individualized ranking scores of restaurants generated by the consumer using a method as described in Section II below.

Instead of, or in addition to values of category rating being provided by consumers for each category, the values for each category may also be curated or assembled from a database of restaurant ratings generated without using a category rating system of the instant disclosure. For instance, values of category ratings may be extracted from a database of restaurant ratings wherein consumers have provided general reviews of restaurants without having specifically provided a value for each category of restaurant rating. When values of category ratings are extracted from a database of consumer general reviews, the values may be curated manually or automatically to extract the values of category ratings.

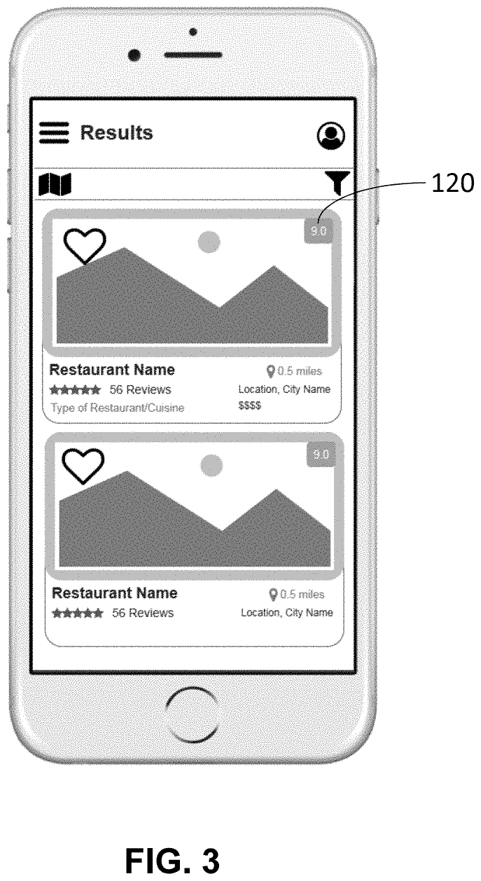

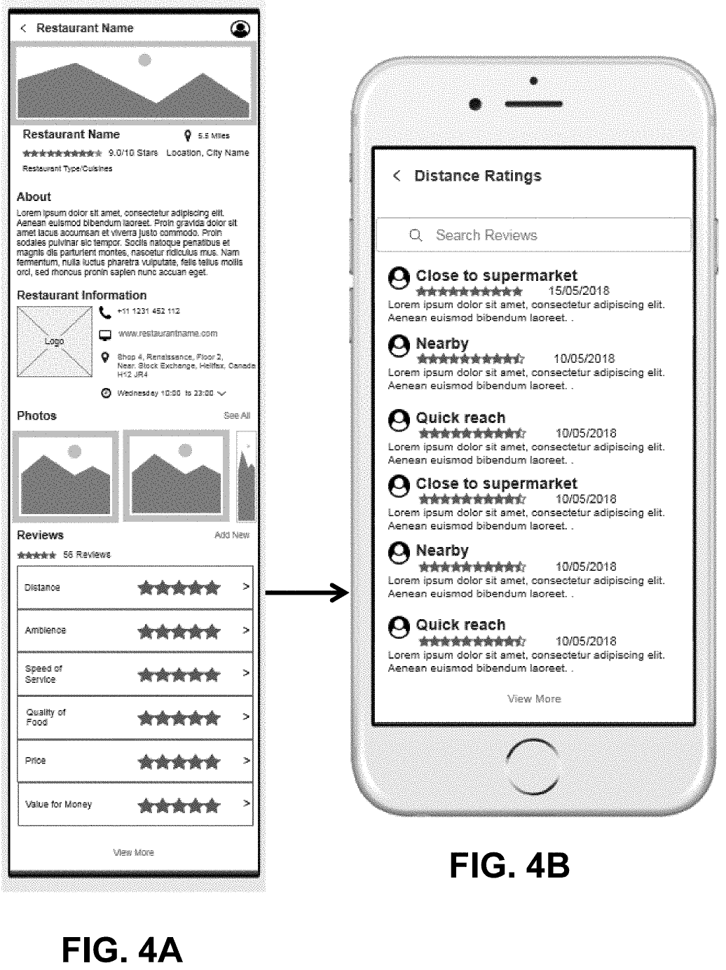

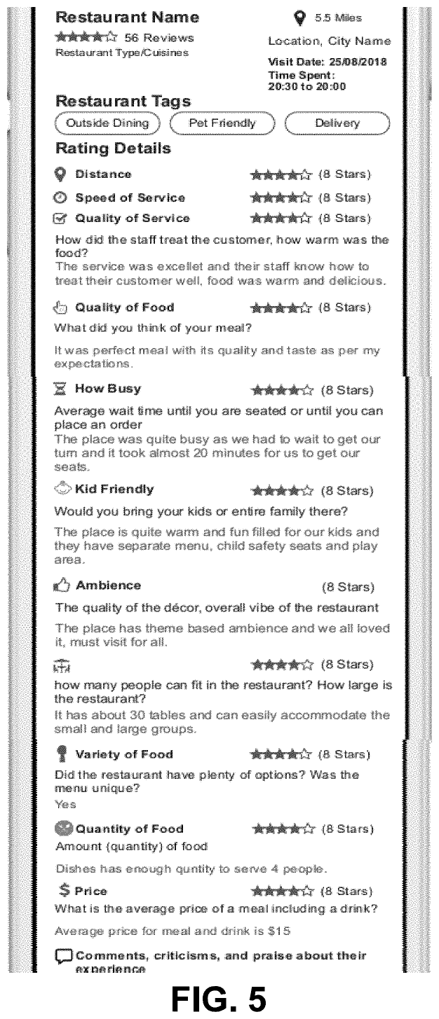

Returning the ranking results to the consumer may comprise returning a ranked list of all the restaurants in the database. Alternatively, any restaurant for which the calculated aggregate score does not satisfy a minimum aggregate score may be excluded from the result. An illustration of a list of results returned to the consumer and showing the aggregate score of each restaurant may be as shown in FIG. 3. A consumer may elect to view detailed category rating data corresponding to each category of restaurant rating for a selected restaurant. The detailed category rating data for each category of restaurant rating may be presented to the consumer as illustrated in FIG. 4A. More detailed rating data for each category of restaurant rating may further be presented to the consumer as shown in FIG. 4B. For instance, a consumer may be presented with consumer comments such as complaints or praise experienced by the consumer for each category of restaurant rating (FIG. 5).

In addition to the ranking of restaurants using the method of the disclosure, the ranking results of restaurants returned to the consumer may further be narrowed by category factors specifying restaurant offerings. Non-limiting category factors that may be used to limit restaurant offerings include food genre, dietary restricted food offerings, dress code, and drive-through.

### II. Generating Individualized Ranking Score

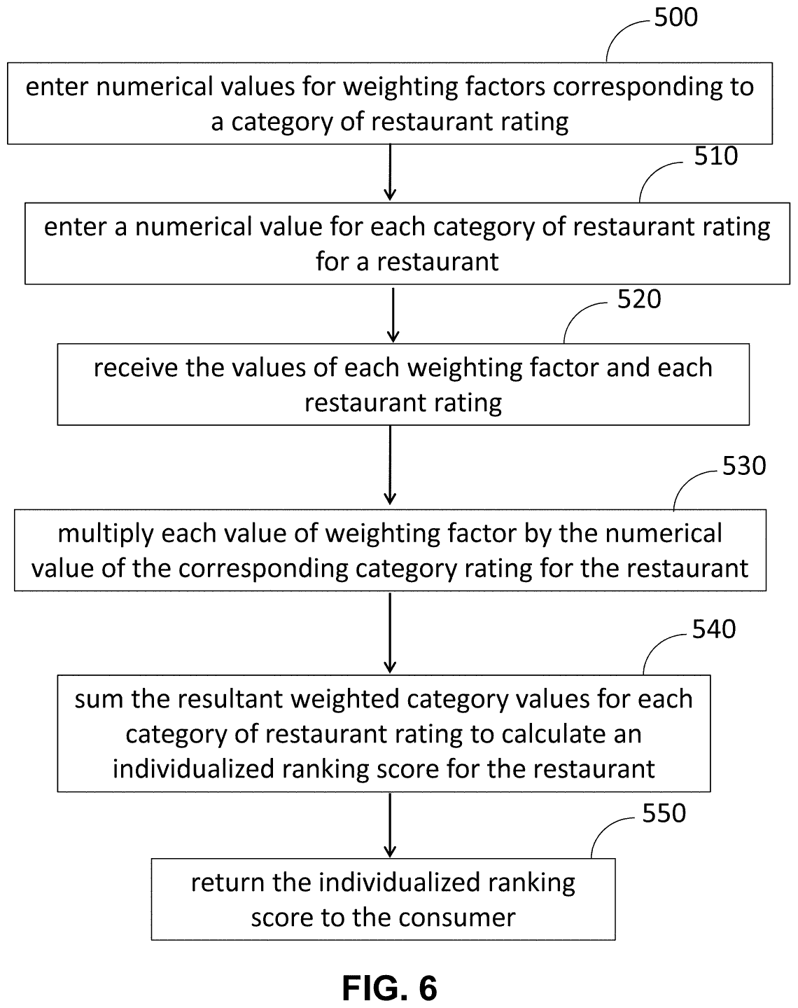

In another aspect, the present disclosure provides methods for generating an individualized ranking score for a restaurant. Referring to the illustrative block diagram of FIG. 6, the method comprises entering by a consumer a value for each of a set of weighting factors 500, wherein each weighting factor corresponds to a category of restaurant rating. Each said value for a weighting factor entered by the consumer represents the relative importance to be given by the consumer to the corresponding category of restaurant rating in ranking the restaurants. The method further comprises entering for a restaurant by the consumer a value for each category of restaurant rating 510. The value of each weighting factor and the value of each category of restaurant rating for the restaurant are received 520. The value of each weighting factor is multiplied by the value of the corresponding category rating for the restaurant to produce a weighted category value for each category of restaurant rating for the restaurant 530. The weight category values for the restaurant are summed to calculate an individualized ranking score for the restaurant 540, for returning to the consumer 550.

The value for each of a set of weighting factors and the process of customizing values of weighting factors may be as described in Section I. The categories of restaurant rating may be as described in Section I above.

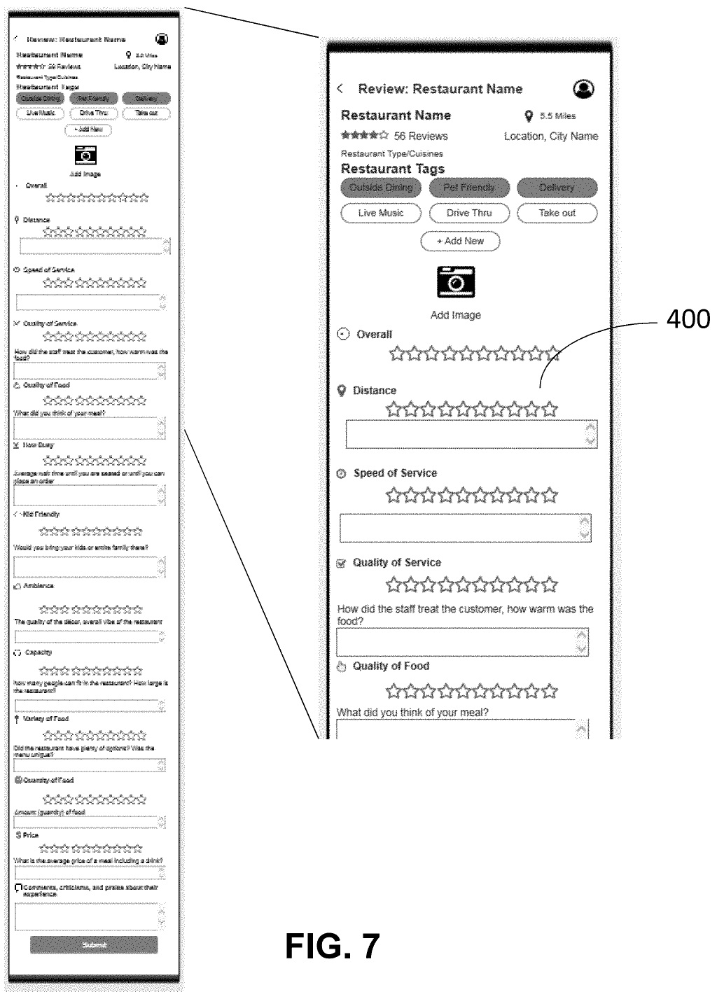

Any number of methods may be used to enter a value for each of a set of weighting factors. For instance, the consumer may enter a value by selecting a value for each category of restaurant rating by moving a slider for selecting the value. Alternatively, the value may be selected by typing the value for each weighting factor. The value may also be selected by selecting the number of stars in a star rating system 400 as illustrated in FIG. 7. Values for weighting factors may be a rating score ranging from 0-100, 0-50, from 0 to 1, preferably from 0-10. Alternatively, the values may be represented by the number of stars in a star rating system. A consumer may further provide comments on each category of restaurant rating such as complaints or praise experienced by the consumer for each category of restaurant rating as described above.

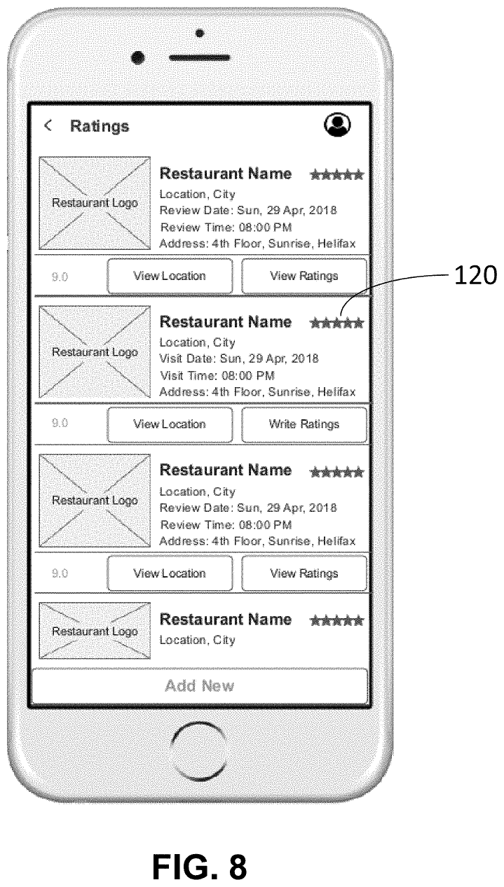

According to a method of the disclosure, after calculating an individualized ranking score for the restaurant, the individualized ranking score for the restaurant is returned to the consumer. An illustration of individualized ranking scores for restaurants rated by the consumer and returned to the consumer may be as shown in FIG. 8. A consumer may elect to view detailed category rating data corresponding to each category of restaurant rating for a selected restaurant. The detailed category ratings for each category of restaurant rating may be presented to the consumer as illustrated in FIG. 4A. More detailed rating data for each category of restaurant rating may further be presented to the consumer as shown in FIG. 4B. For instance, a consumer may be presented with consumer comments such as complaints or praise experienced by the consumer for each category of restaurant rating (FIG. 5).

A method of the disclosure may further comprise the additional steps of generating an individualized ranking score for each restaurant in a list of restaurants other than the first restaurant. After generating an individualized ranking score for each restaurant, the restaurants are ranked based on the calculated individualized ranking score to produce a ranking result for each restaurant in the list. The ranking results are then returned to the consumer, wherein the ranking results are listed in an order corresponding to the ranking result of each restaurant. Further, the generated values for each category of restaurant rating for a restaurant or all restaurants in the list of restaurants may be contributed to a database of averaged values of category rating data in a list of restaurants.

In addition to the ranking of restaurants using weighting factors, the ranking results of restaurants returned to the consumer may further be narrowed by category factors specifying restaurant offerings. Non-limiting category factors that may be used to limit restaurant offerings include food genre, dietary restricted food offerings, dress code, and drive-through.

In some embodiments, the value for each category of restaurant rating is further contributed to a searchable database of values of restaurant rating data for each restaurant as individualized by the consumer and other consumers using a method of the disclosure. Such a database may be used in methods of ranking restaurants described in Section I.

### III. Contributing to a Database of Restaurant Category Ratings

Another aspect of the disclosure is directed to a machine implemented method of contributing to a database of restaurant category rating data. The method comprises entering by a consumer for a restaurant in the database a value for one or more category of restaurant rating. The method further comprises receiving the values for the one or more category from the consumer, and averaging the values for each of the one or more category received from the consumer with values contributed by other consumers for each corresponding one or more category.

### IV. Restaurant Ranking System

Other aspects of the disclosure are directed to a restaurant ranking system comprising a processor and a computer readable storage medium. The storage medium causes the processor to perform operations. The operations comprise receiving information from a consumer relating to a method of ranking restaurants in a personal restaurant scoring system or to a method of generating an individualized ranking score of restaurants in a restaurant scoring system. The method further comprises performing the steps of the method and returning results of the method to the consumer. The methods and the steps of the methods may be as described in Sections I and II.

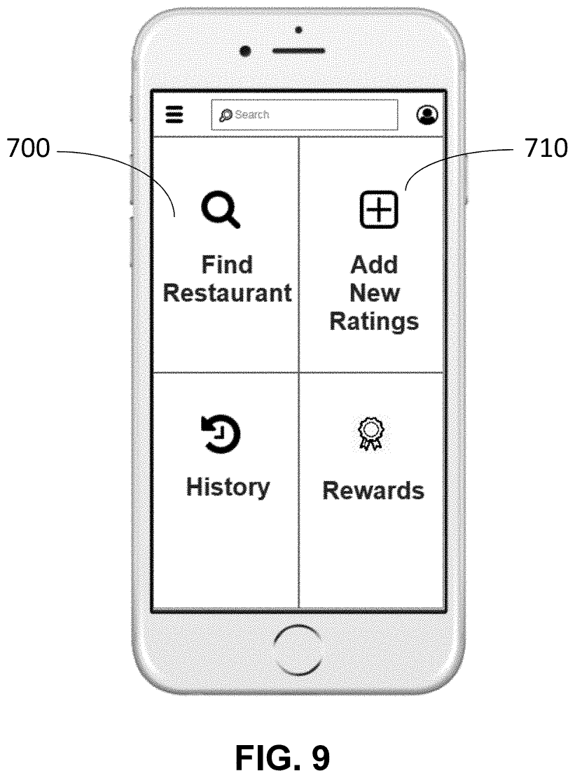

In some embodiments, a system may be used for both methods. For instance, in a method of the disclosure, a consumer may be presented with an option to elect finding a restaurant using the method of ranking restaurants in a personal restaurant scoring system as described in Section I, or elect to add new ratings to a restaurant using a method of generating an individualized ranking score of restaurants. An example of presenting a consumer with an option to elect finding a restaurant 700 or to add new ratings to a restaurant 710 may be as illustrated in FIG. 9.

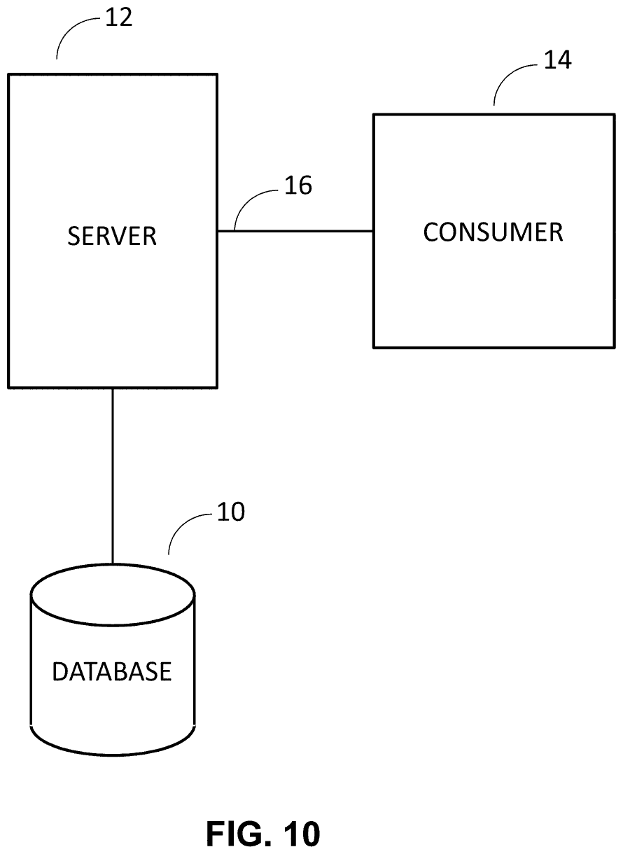

Consumers may be remote. Referring to FIG. 10, when consumers are remote, consumers typically would use a mobile device but could use any device capable of remotely connecting to a server 12 to initiate a query and receive a response from a query. This would include, without limitation, a web television device, a personal data assistant, wireless communication device, or other computer. Information relating to restaurant ratings is stored in the database 10. Additionally, the database 10 stores a set of weighting factors. The database 10 is connected to the server 12. The server 12 receives queries from consumers 14 who may be located at remote locations and access the processor on the server 12 through the internet 16.

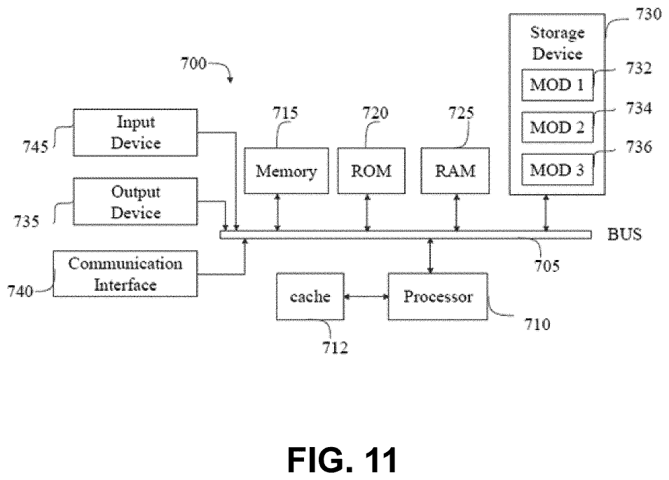

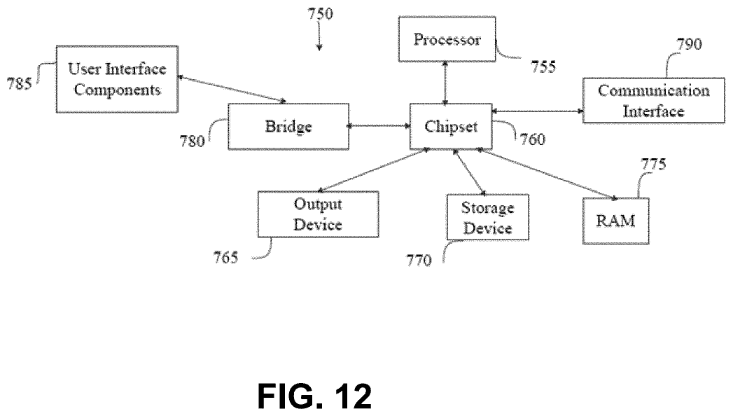

FIG. 11 and FIG. 12 illustrate example system embodiments. The more appropriate embodiment will be apparent to those of ordinary skill in the art when practicing the present technology. Persons of ordinary skill in the art will also readily appreciate that other system embodiments are possible.

FIG. 11 illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communication interface 740 can generally govern and manage the user input and system output. There is no restriction on operating on any particular hardware arrangement, and therefore the basic features here may easily be substituted for improved hardware or firmware arrangements as they are developed.

Storage device 730 is a non-volatile memory and can be a hard disk or other type of computer readable media which can store data that is accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 12 illustrates an example computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output device 765, such as a display, and can read and write information to storage device 770, which can include magnetic media and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface, or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that example systems 700 and 750 can have more than one processor or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer readable storage devices, mediums, and memories can include a cable or wireless signal containing a bit stream and the like. However, when mentioned, non-transitory computer readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further, and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

Reference to “one embodiment”, “an embodiment”, or “some embodiments” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or” includes any and all combinations of one or more of the associated listed items.

When an element is referred to as being “connected” or “coupled” to another element, it can be directly connected or coupled to the other element, or intervening elements may be present. By contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular examples only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer readable medium” may include, but is not limited to, portable or fixed storage devices, optical storage devices, and various other mediums capable of storing, containing or carrying instruction(s) and/or data.

Furthermore, examples may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Additional features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

While several particular embodiments of the present disclosure have been described herein, it will be appreciated by those skilled in the art that changes and modifications may be made thereto without departing from the disclosure in its broader aspects and as set forth in the following claims.

What is claimed is:

1. A machine implemented method of ranking restaurants in a personal restaurant scoring system, the method comprising:
a. entering by a consumer a value for each of a set of weighting factors prior to receiving query information related to a potential selection of a restaurant, wherein each weighting factor corresponding to a category of restaurant rating and wherein the value corresponding to each said weighting factor represents the relative importance to be given by the consumer to the category of restaurant rating corresponding in ranking the restaurants;
b. receiving from the consumer the query information related to a potential selection of a restaurant;
c. applying the values of weighting factors to a list of restaurants from a database of values of category ratings for each restaurant, wherein applying the values of weighting factors comprises multiplying each value of a weighting factor by a value of the corresponding category rating in the database, to produce a weighted category value for each category of restaurant rating;
d. summing the weighted category values for each restaurant in the database to calculate a restaurant aggregate score for each said restaurant in the database;
e. ranking said list of restaurants based on the calculated restaurant aggregate scores to produce a ranking result for each restaurant; and
f. returning the ranking results to the consumer, wherein the ranking results are listed in an order corresponding to the ranking result of each restaurant.

2. The method of claim 1, wherein any restaurant for which the aggregate score does not satisfy a minimum aggregate score for said restaurant is excluded from the ranking results.

3. The method of claim 1, wherein the value is a rating score from 0-1.

4. The method of claim 3, wherein the values of the weighting factors entered by a consumer sum to 1.

5. The method of claim 1, wherein the values for each of the weighting factors are selected by the consumer from a list of weighting factors.

6. The method of claim 1, wherein values for weighting factors not weighted by the consumer are attributed a value of 0.

7. The method of claim 1, wherein each value of weighting factors is pre-set by the consumer with the same value until modified by the consumer.

8. The method of claim 1, wherein the categories of restaurant rating are selected from price, quality of service, speed of service, quality of food, variety of food, popularity, crowdedness, kid friendliness, distance from a location, healthiness of food served, serving size, ambiance, food portion size, drink variety, presence or absence of televisions, and capacity.

9. The method of claim 1, wherein the value of restaurant category rating ranges from 0-10.

10. The method of claim 1, wherein the database of ratings is contributed by consumers.

11. The method of claim 1, wherein the ranking results of restaurants is further narrowed by category factors specifying restaurant offerings.

12. The method of claim 11, wherein the category factors specifying restaurant offerings are selected from food genre, dietary restricted food offerings, dress code, and drive-through.

13. The method of claim 1, wherein the method of ranking is implemented remotely.

14. The method of claim 1, wherein the method of ranking is implemented on a mobile device.

15. A machine implemented method of generating an individualized ranking score for a restaurant, the method comprising:
a. entering by a consumer a value for each of a set of weighting factors, wherein each weighting factor corresponding to a category of restaurant rating and wherein the value corresponding to each said weighting factor represents the relative importance to be given by the consumer to the corresponding category of restaurant rating in ranking the restaurants;
b. entering for a first restaurant by the consumer a value for each category of restaurant rating;
c. receiving the value for each weighting factor and the value of each category for restaurant rating;
d. multiplying the value of each weighting factor by the value of the corresponding category rating for the first restaurant, to produce a weighted category value for each category of restaurant rating for the restaurant;
e. summing the weighted category values for the restaurant to calculate an individualized ranking score for the restaurant; and
f. returning the individualized ranking score to the consumer.

16. The method of claim 15, wherein the method comprises the additional steps of:
a. repeating steps a-e for each restaurant in a list of restaurants other than the first restaurant, thereby generating an individualized ranking score for each restaurant in the list;
b. ranking said list of restaurants based on the calculated individualized ranking score to produce a ranking result for each restaurant in the list; and
c. returning the ranking results to the consumer, wherein the ranking result for each restaurant in the list is listed in an order corresponding to the ranking result of each restaurant.

17. The method of claim 16, wherein the value for each category of restaurant rating is contributed to a database of averaged values of category rating data for each restaurant in a list of restaurants.

18. (canceled)

19. A restaurant ranking system comprising:
a. a processor; and
b. a computer readable storage medium storing instructions which, when executed by the processor, cause the processor to perform operations comprising:
i. receiving information from a consumer relating to a method of ranking restaurants in a personal restaurant scoring system or to a method of generating an individualized ranking score of restaurants in a restaurant scoring system;
ii. performing the steps of the method to generate a result; and
iii. returning the result to the consumer.
